(19) United States
(12) Patent Application Publication
(10) Pub. No.: US 2024/0030567 A1
(43) Pub. Date: Jan. 25, 2024

(54) BATTERY AND ELECTRIC APPARATUS

(71) Applicant: Ningde Amperex Technology Limited, Ningde City (CN)

(72) Inventors: Yanru ZHANG, Ningde (CN); Haijiao Hao, Ningde (CN); Jianzheng SUN, Ningde (CN); Shengyu Hao, Ningde (CN)

(73) Assignee: Ningde Amperex Technology Limited, Ningde City (CN)

(21) Appl. No.: 18/355,473

(22) Filed: Jul. 20, 2023

(30) Foreign Application Priority Data
Jul. 20, 2022 (CN) 202210859890.6

(51) Int. Cl. H01M 50/538; H01M 50/536; H01M 50/586

(52) U.S. Cl. CPC H01M 50/538; H01M 50/536; H01M 50/586; H01M 2220/30

(57) ABSTRACT

A battery includes a housing, a battery cell, and a first conductive member. The housing is provided with an accommodating cavity, and the battery cell is accommodated in the accommodating cavity. The first conductive member includes a first terminal part located outside the housing, and a first connecting part connected to the first terminal part and located inside the housing. The battery cell includes an electrode assembly and N first tabs protruding from the electrode assembly, where N is an integer greater than 1. The N first tabs are divided into M first tab groups. The first tab groups are mutually separately connected to one side of the first connecting part facing the electrode assembly. M is an integer greater than or equal to 1 and less than or equal to N.

### CROSS REFERENCE TO THE RELATED APPLICATIONS

This application claims priority from Chinese Patent Application No. 202210859890.6, filed on Jul. 20, 2022, the entire contents of which are incorporated herein by reference in its entirety.

### TECHNICAL FIELD

This application relates to the technical field of batteries, and in particular, to a battery and an electric apparatus.

### BACKGROUND

The rapid rise of fossil energy demand and the increasing environmental protection requirements accelerate the development of alternative clean energy. Electrochemical energy, as alternative clean energy, has attracted more and more research and attention in its development and utilization. At present, as a typical example using electrical energy-chemical energy converting apparatuses, batteries have been used in various fields more and more widely and have become an indispensable part of people's lives.

Batteries generally include consumer batteries, traction batteries and energy storage batteries. The consumer batteries are generally used in portable devices, for example, electric apparatuses such as mobile phones, video cameras, and notebook computers; the traction batteries are used in electric apparatuses such as electric vehicles and electric bicycles; and the energy storage batteries are used in energy storage power stations. The consumer batteries, the traction batteries and the energy storage batteries all generally include a housing and an electrode assembly accommodated in an accommodating cavity of the housing.

The existing batteries are mainly classified into laminated structures and wound structures. The former is a combination of multiple laminates formed by stacking a first electrode plate, a separator and a second electrode plate in sequence. The latter is formed by wounding a first electrode plate, a separator and a second electrode plate that have been stacked in sequence. The first electrode plate includes a first current collector and a first active material layer provided on the first current collector. The second electrode plate includes a second current collector and a second active material layer provided on the second current collector. The first active material layer can be intermittently or continuously applied on the first current collector. The second active material layer can be intermittently or continuously applied on the second current collector. For a wound structure, the first current collector and the second current collector are each provided with a continuous region that has a specified width and is provided with no active substance layer at the edge along the winding direction; and the region of the first current collector that is provided with no active substance layer and the region of the second current collector that is provided with no active substance layer are located at two opposite ends of a wound body and form a first electrode plate full tab and a second electrode plate full tab, respectively. Alternatively, the regions of the first current collector and second current collector that are provided with no active material layer are respectively die-cut to form first tabs or second tabs.

In order to meet the requirements of high rate and fast charge of batteries, a multi-tab structure is usually required, that is, the regions of the first current collector and second current collector that are provided with no active material layer are respectively die-cut to form multiple separated first tabs or second tabs. In the prior art, as shown in FIG. 27, generally multiple first tabs 115 or multiple second tabs need to be stacked, folded, and then adaptively welded to one side of a first conductive member 33 or a second conductive member away from an electrode assembly 10a, and a partial structure of the first conductive member 33 or second conductive member extends out of the housing, so as to lead out electrical conduction of the multiple first tabs or the multiple second tabs out of the housing. However, such structure formed by multiple tabs that are stacked, folded and then adaptively welded to a conductive member occupies a large space in a battery (as shown in FIG. 27, the first conductive member 33 and the electrode assembly 10a have a large distance d, resulting in a lower volumetric energy density. In addition, during subsequent assembly production and use (for example, falling of a battery), the conductive member in such structure is likely to be reversely inserted into the electrode assembly due to influence of a pulling force generated during stacking and folding of the multiple tabs and accordingly leads to a contact short circuit, finally resulting in outbreak of smoke and fire of batteries and causing safety accidents.

### SUMMARY

This application is intended to provide a battery and an electric apparatus. A multi-tab structure connection method for such battery can release an internal space, occupied by multiple tabs, of the housing and increase the volumetric energy density, and can also reduce the risk of a contact circuit short caused when the conductive member is reversely inserted into the electrode assembly, so as to improve the safety. In addition, the utilization of a current collector can be improved, and costs can be reduced.

To achieve the foregoing objectives, this application provides a battery including a housing, a battery cell and a first conductive member. The housing is provided with an accommodating cavity, and the battery cell is accommodated in the accommodating cavity. The first conductive member includes a first terminal part located outside the housing, and a first connecting part connected to the first terminal part and located inside the housing. The battery cell includes an electrode assembly and N first tabs protruding from the electrode assembly, where N is an integer greater than 1. The N first tabs are divided into M first tab groups, where the first tab groups are mutually separately connected to one side of the first connecting part facing the electrode assembly, and M is an integer greater than or equal to 1 and less than or equal to N.

Compared with the prior art, the battery of a multi-tab structure in this application has multiple first tabs divided into M groups, and the groups are mutually separately connected to one side of the first connecting part facing the electrode assembly. In such structure, the multiple first tabs do not need to be stacked, folded and then connected to one side of the first conductive member away from the electrode assembly, so that the internal space, occupied by the multiple tabs, of the housing can be released, thereby increasing the volumetric energy density. Besides, the first conductive member is not affected by the pulling force generated during stacking and folding of the multiple first tabs. This can reduce the risk of a contact short circuit caused when the first conductive member is reversely inserted into the electrode assembly, thereby improving the safety. In addition, the multiple first tabs do not need to be stacked or folded, so that the first tabs between the first connecting part and the electrode assembly can be controlled to have a small size, thereby reducing costs.

It is worth noting that in this application, “mutually separately connected to” in the sentence that the first tab groups are mutually separately connected to one side of the first connecting part facing the electrode assembly means that the first tab groups are connected to one side of the first connecting part facing the electrode assembly by welding or adhesion; each first tab group includes at least one welding spot; however, when the first connecting part has a small size or there are lots of first tab groups, the adjacent first tab groups have a short distance, and it is possible that the first tabs in the adjacent first tab groups make contact with each other or welding mark edges overlap. This does not exceed the scope of the “mutually separately connected to” described in this application. Moreover, in this application, “one side facing the electrode assembly” in the sentence that the first tab groups are mutually separately connected to one side of the first connecting part facing the electrode assembly refers to a side from two opposite surfaces of the first connecting part closer to the electrode assembly. For example, when the first connecting part is L-shaped, the side thereof facing the electrode assembly not only includes a horizontal surface directly facing the electrode assembly but also includes a folded surface and a vertical surface closer to the electrode assembly with respect to an inner side of the first connecting part.

In an embodiment, M is equal to N, and the N first tabs are mutually separately directly connected to one side of the first connecting part facing the electrode assembly. In other words, the multiple first tabs are directly connected to the first conductive member respectively, with a simple operation process.

In an embodiment, the N first tabs are divided into M first tab groups, where M is an integer greater than or equal to 1 and less than N. The M first tab groups include P first tab groups I and Q first tab groups II. The first tab group I includes one first tab, and the first tab group II includes multiple first tabs. P is an integer greater than or equal to 0 and less than M, and Q is an integer greater than 0 and less than or equal to M, where P+Q=M. The multiple first tabs in the first tab group II are stacked and welded to form a first assembly part. The first tabs of the P first tab groups I and the Q first assembly parts are mutually separately connected to one side of the first connecting part facing the electrode assembly. The multiple first tabs are firstly grouped, pre-welded and then connected to the first connecting part, thereby reducing the risk of a rosin joint or poor welding caused by mutual interference of lots of first tabs that are present.

In an embodiment, the first connecting part and the electrode assembly has a distance less than 1 mm. The distance being controlled as this parameter can not only meet connection requirements but also increase the volumetric energy density.

In an embodiment, the electrode assembly includes a wound body formed by stacking and wounding a first electrode plate, a separator and a second electrode plate in sequence, and N first tabs forms N layers of tab rolls around a central axis of the wound body. This means that a full-tab structure is used, thereby reducing a safety risk caused by formation of burrs during die cutting of the first tabs.

In an embodiment, the electrode assembly is formed by stacking and wounding a first electrode plate, a separator and a second electrode plate in sequence; or the electrode assembly is formed by stacking multiple first electrode plates, separators and second electrode plates in sequence, and a direction that vertically runs through the first electrode plates, the separators and the second electrode plates is defined as a first direction.

In an embodiment, the N first tabs are separated from each other in a winding direction or the first direction. Compared with the full-tab structure, the mutually separated first tabs are more convenient to connect to the first conductive member.

In an embodiment, the electrode assembly includes a first electrode plate, a second electrode plate, and a separator spaced between the first electrode plate and the second electrode plate; the first electrode plate includes a first current collector and a first active substance layer provided on the first current collector; the first current collector extends to form the first tab; the first current collector is provided with an insulating layer; and the insulating layer is in contact with the first active substance layer and extends to the first tab. The insulating layer can be provided to cover the burrs on an edge after the first tab is formed on the first current collector through die cutting, thereby reducing safety risks such as a short circuit caused by contact with the second electrode plate. The insulating layer may be made of at least one of boehmite, aluminum oxide and magnesium oxide.

In an embodiment, a direction in which the first tab protrudes from the electrode assembly is defined as a second direction; and the second electrode plate includes a second current collector and a second active substance layer provided on the second current collector. The first electrode plate a cathode electrode plate, and the second electrode plate is an anode electrode plate. In the second direction, an edge of the insulating layer is flush with an edge of the second active substance layer. In the arrangement of this structure, the insulating layer can cover the burrs of the edge after the first tab is formed on the first current collector through die cutting, thereby reducing a safety risk such as a short circuit caused by contact with an anode electrode plate. More importantly, the multiple first tabs in this application do not need to be stacked and folded to one side of the first conductive element far away from the electrode assembly, so that it is less likely to cause reverse insertion of the first conductive member into the electrode assembly. Therefore, the insulating layer may be provided with a small size in the second direction, and specifically the edge of the insulating layer can be controlled to be flush with the edge of the second active substance layer. In other words, the size of the insulating layer in the second direction only needs to satisfy the requirement of reducing the safety risk caused by contact between the first current collector and the anode lectrode plate. Therefore, under a condition that the safety of the battery is unchanged, the production cost can be reduced and the energy density can be increased.

In an embodiment, a ratio of a length of the first tab to a distance between the first connecting part and the electrode assembly is (2-8): 1. The length of the first tab refers to a length of a portion, that exceeds the electrode assembly before welding, of the first tab of the electrode assembly. With the foregoing ratio range being controlled, the length of each first tab on the electrode assembly before the first tab is welded can be better controlled within an appropriate range according to a preset distance between the first connecting part and the electrode assembly, thereby preventing mutual interference between each first tab group and the first connecting part in welding due to an excessively large length of the first tab, and also preventing insufficient welding strength due to short welded portions of each first tab group and the first connecting part caused by an excessively small length of the first tab.

This application further provides an electric apparatus including the foregoing battery. The electric apparatus may be an electronic product such as a mobile phone, a video camera, a notebook computer, a drone, an electric vehicle, an electric bicycle, or an energy storage power station.

### BRIEF DESCRIPTION OF DRAWINGS

FIG. 1 is a schematic diagram of an electric apparatus according to an embodiment of this application.

FIG. 2 is a three-dimensional diagram of a battery according to a first embodiment of this application.

FIG. 3 is an exploded view of the battery in FIG. 2.

FIG. 4 is a three-dimensional diagram of a battery according to a second embodiment of this application.

FIG. 5 is a three-dimensional diagram of an electrode assembly in the battery shown in FIG. 4 according to an embodiment.

FIG. 6 is a variation diagram of FIG. 5.

FIG. 7 is another variation diagram of FIG. 5.

FIG. 8 is still another variation diagram of FIG. 5.

FIG. 9 is a local schematic cross-sectional view along direction a-a in FIG. 4.

FIG. 10 is a variation diagram of FIG. 9.

FIG. 11 is a local cross-sectional view along direction b-b in FIG. 5.

FIG. 12 is a local cross-sectional view along direction c-c in FIG. 5.

FIG. 13 is a three-dimensional diagram of the electrode assembly in the battery shown in FIG. 4 according to another embodiment.

FIG. 14 is a variation diagram of FIG. 13.

FIG. 15 is a schematic diagram of a first electrode plate of the electrode assembly in FIG. 5.

FIG. 16 is a first variation diagram of FIG. 15.

FIG. 17 is a second variation diagram of FIG. 15.

FIG. 18 is a third variation diagram of FIG. 15.

FIG. 19 is a fourth variation diagram of FIG. 15.

FIG. 20 is a fifth variation diagram of FIG. 15.

FIG. 21 is a sixth variation diagram of FIG. 15.

FIG. 22 is a seventh variation diagram of FIG. 15.

FIG. 23 is a schematic diagram of a second electrode plate of the electrode assembly in FIG. 5.

FIG. 24 is a first variation diagram of FIG. 15.

FIG. 25 is a second variation diagram of FIG. 15.

FIG. 26 is a third variation diagram of FIG. 15.

FIG. 27 is a local schematic cross-sectional view of a battery in the prior art.

### REFERENCE SIGNS OF COMPONENTS

200—mobile phone;

100—battery;

10—battery cell;

10a—electrode assembly;

11—first electrode plate;

111—first current collector;

111a—first part;

111b—second part;

113—first active substance layer;

115—first tab;

117—first tab group;

119—first assembly part;

13—second electrode plate;

131—second current collector;

131a—third part;

131b—fourth part;

133—second active substance layer;

135—second tab;

137—second tab group;

139—second assembly part;

15—separator;

17—insulating layer;

30—cover assembly;

31a—first end cover;

31b—second end cover;

33—first conductive member;

331—first connecting part;

333—first terminal part;

35—conductive member;

351—second connecting part;

353—second terminal part;

37—electrolyte injection hole;

50—housing;

A—first direction/winding direction;

B—second direction;

C—third direction;

d—distance between first conductive member and electrode assembly;

d1—distance between first connecting part and first part;

d2—size of first tab exceeding separator in suspended state in second direction;

d3—distance between adjacent first tabs;

d4—size of first tab in suspended state in second direction;

d5—size of first tab in winding direction;

d6—distance between adjacent second tabs;

d7—size of second tab in suspended state in second direction; and

d8—size of first tab in winding direction.

### DETAILED DESCRIPTION

For better description of the objectives, technical solutions and beneficial effects of this application, this application will further described below with reference to specific embodiments. It should be noted that the following implementations are merely intended to further describe this application, and shall not be construed as a limitation on this application.

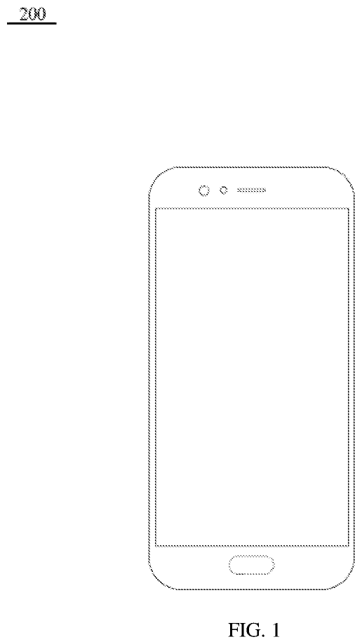

This application relates to a battery of a multi-tab structure. This battery can meet the use requirements of various electric apparatuses, for example, mobile phones (as shown in FIG. 1), video cameras, notebook computers, electric vehicles, electric bicycles, drones, and energy storage power stations.

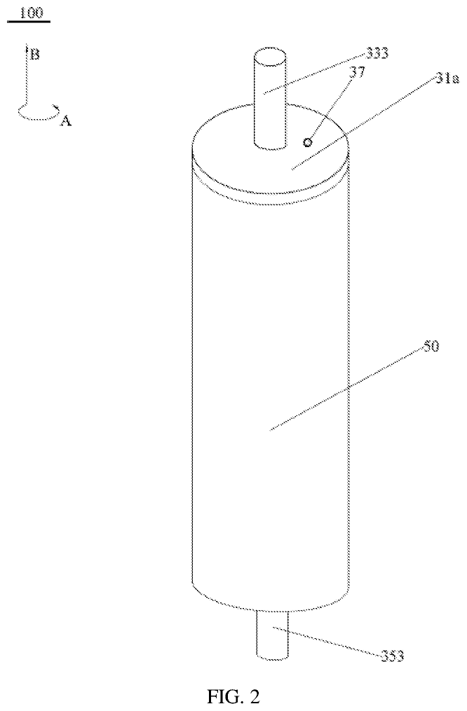

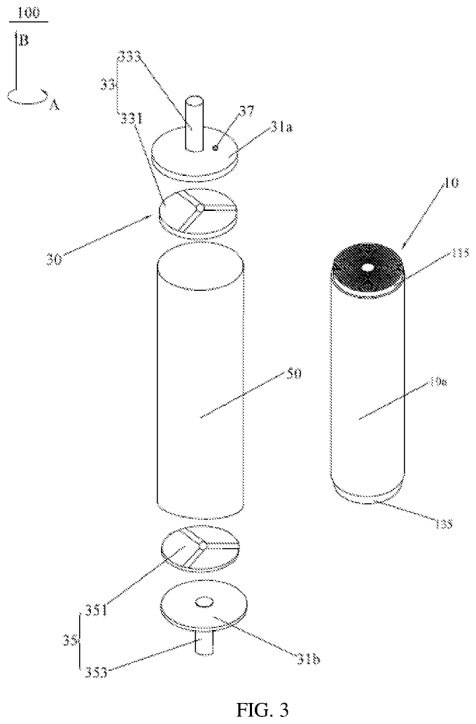

The battery in this application may be appropriate for a cylindrical battery or a square battery. A cylindrical battery 100 as shown in FIG. 2 and FIG. 3 includes a housing 50, a battery cell 10 accommodated in the housing 50, and a cover assembly 30 for sealing the housing 50. The cover assembly 30 includes a first end cover 31a and a second end cover 31b that are provided at two opposite openings of the housing 50. The first end cover 31a is provided with an electrolyte injection hole 37 and a first conductive member 33. The second end cover 31b is provided with a second conductive member 35. The first conductive member 33 includes a first terminal part 333 located outside the housing 50, and a first connecting part 331 located inside the housing 50. The second conductive member 35 includes a second terminal part 353 located outside the housing 50, and a second connecting part 351 located inside the housing 50. The battery cell 10 includes an electrode assembly 10a as well as a first tab 115 and a second tab 135 that protrude from two opposite ends of the electrode assembly 10a, where the first tab 115 and the second tab 135 are respectively connected to the first connecting part 331 and the second connecting part 351. A specific connection manner may be welding, or adhesion by a conductive adhesive. In short, electrical connection between the tab and the connecting part should be satisfied. The housing 50 is generally made of a material of metal aluminum, stainless steel or magnesium alloy, and is formed by stretching a sheet. The first conductive member 33 and the second conductive member 35 may be metal members or conductive composite materials, and should meet a requirement of leading out electrical conduction of the first tab 115 or the second tab 135 out of the housing.

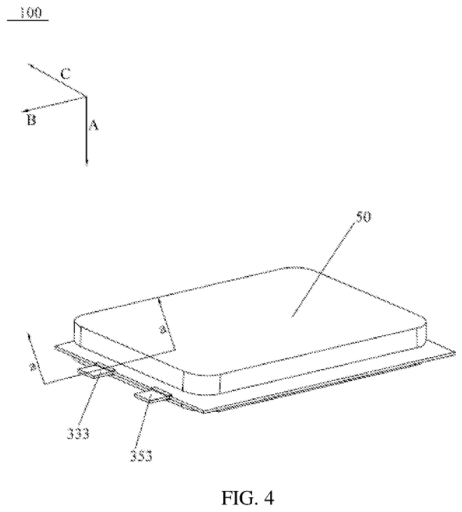

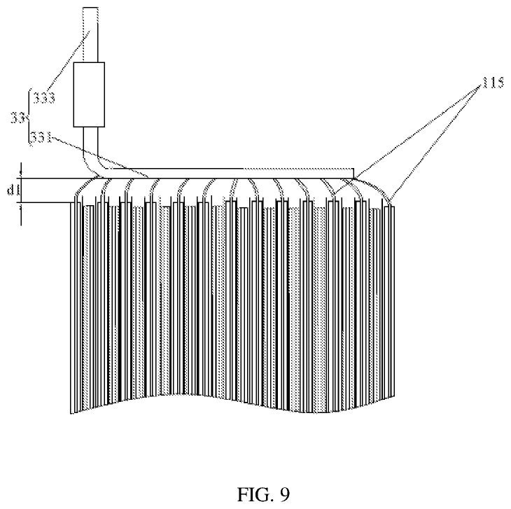

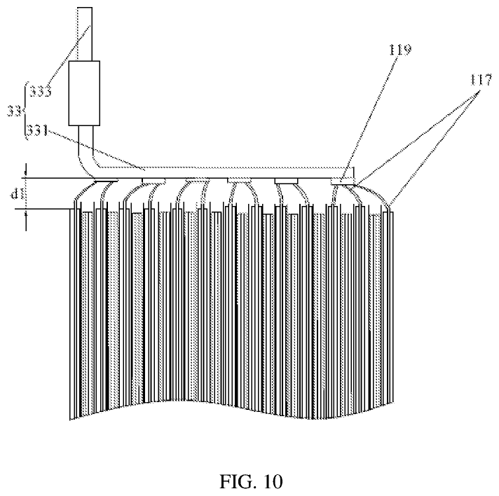

Alternatively, as shown in FIG. 4, FIG. 9 and FIG. 10, a prolate battery 100 includes a housing 50, a battery cell 10, a first conductive member 33 and a second conductive member 35. The battery cell 10 is accommodated in an accommodating cavity formed in the housing 50 and includes an electrode assembly 10a as well as a first tab 115 and a second tab 135 that protrude from the electrode assembly 10a in a same direction. The first conductive member 33 includes a first terminal part 333 located outside the housing 50, and a first connecting part 331 located inside the housing 50. The second conductive member 35 includes a second terminal part 353 located outside the housing 50, and a second connecting part 351 located inside the housing 50. The first tab 115 and the second tab 135 are respectively connected to the first connecting part 331 and the second connecting part 351. A specific connection manner may be welding, or adhesion by a conductive adhesive. In short, electrical connection between the tab and the connecting part should be satisfied. The housing 50 is generally a three-layer structure, in which a middle layer is a metal foil, and two sides are polymer layers. The metal foil may be made of a material of aluminum, steel, titanium, alloy, or the like. Similarly, the first conductive member 33 and the second conductive member 35 may be metal members or conductive composite materials, and should meet a requirement of leading out electrical conduction of the first tab 115 or the second tab 135 out of the housing.

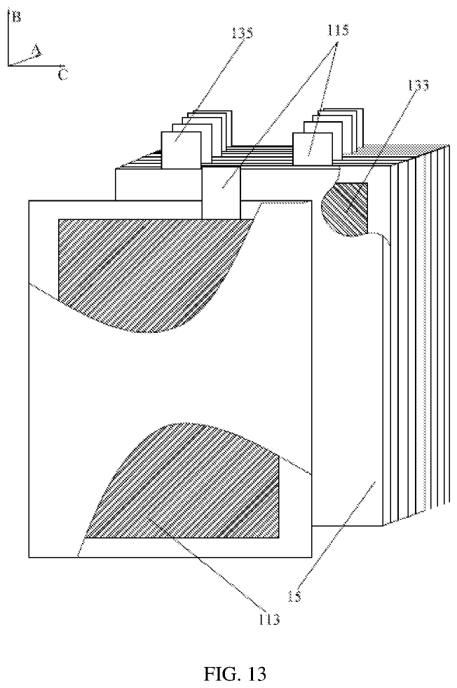

In this application, the electrode assembly 10a of the battery 100 may be a wound structure shown in FIG. 5 to FIG. 12, where the electrode assembly 10a includes a wound body formed by stacking and winding a first electrode plate 11, a separator 15 and a second electrode plate 13 in sequence. Alternatively, the electrode assembly 10a may be a laminated structure shown in FIG. 13 and FIG. 14, where the electrode assembly 10a is formed by stacking multiple first electrode plates 11, separators 15 and second electrode plates 13 in sequence. For a wound structure, a winding direction is defined as A, and a direction in which the first conductive member 33 extends out of the housing 50 is defined as a second direction B. Alternatively, for a laminated structure, a direction in which the first conductive member 33 extends out of the housing 50 is defined as a second direction B, and a direction perpendicular to the second direction B and vertically running through the first electrode plates 11, the second electrode plates 13 and the separators 15 is defined as a first direction A. In addition, a direction perpendicular to both the first direction A and the second direction B is a third direction C.

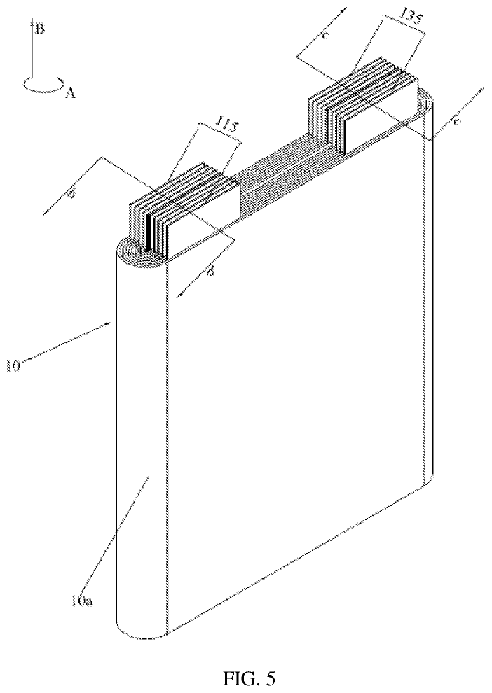

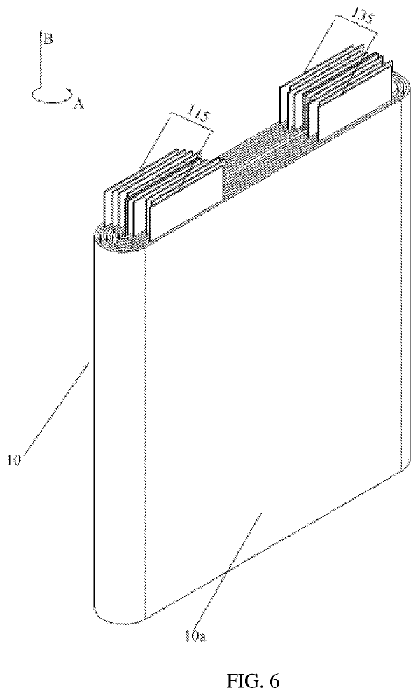

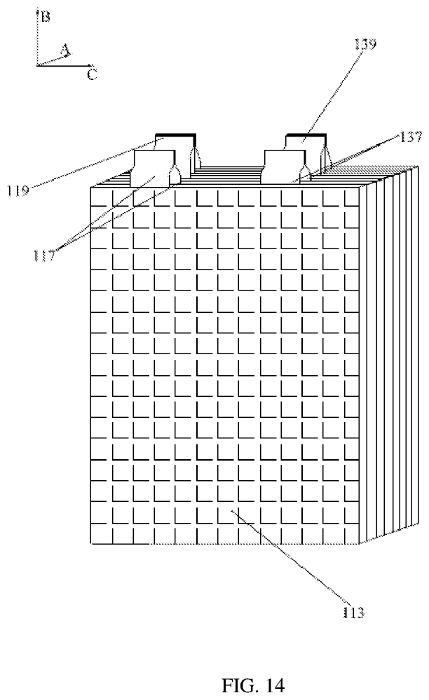

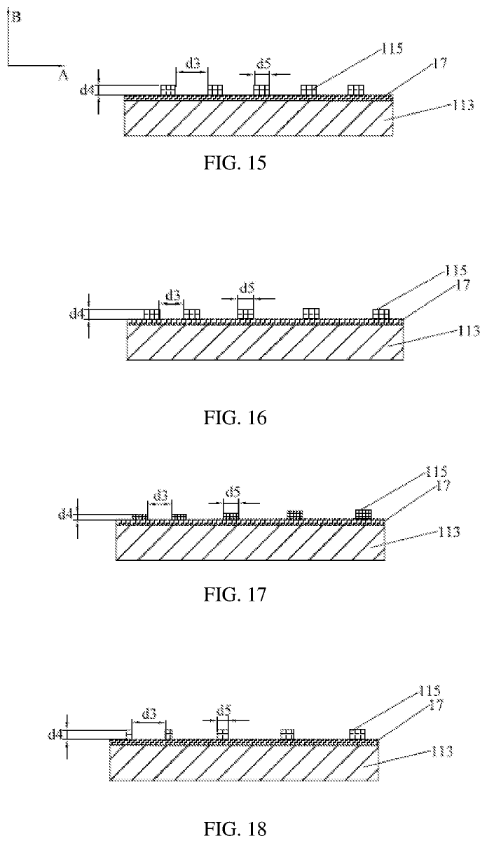

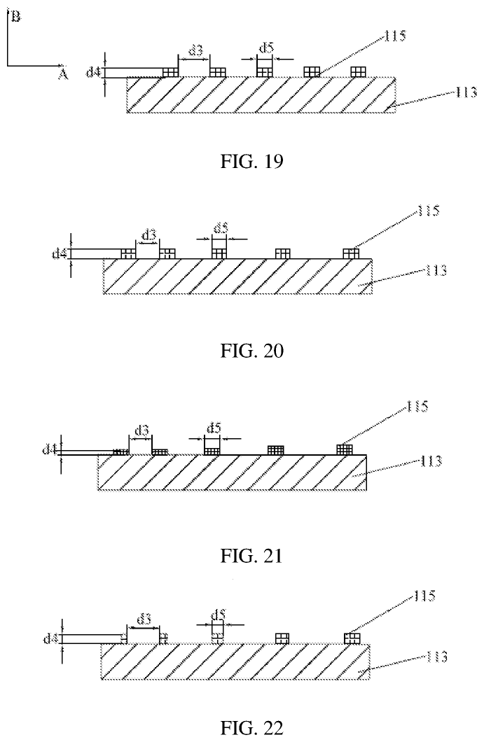

Firstly, the electrode assembly 10a of a wound structure is described with reference to FIG. 5 to FIG. 12. The first electrode plate 11 includes a first current collector 111 and a first active substance layer 113 provided on the first current collector 111. In the second direction B, the first current collector 111 includes a first part 111a provided with the first active substance layer 113 and a second part 111b provided with no first active substance layer 113. In the winding direction A, N first tabs 115 are integrally formed on the second part 111b. Alternatively, in the winding direction A, N first tabs 115 are welded or electrically adhered to the first current collector 111, where N is an integer greater than 1. For ease of description, the first tabs 115 formed in the former manner are used as an example for description. The N first tabs 115 are divided into M groups. The groups are mutually separately connected to one side of the first connecting part 331 facing the electrode assembly 10a, where M is an integer greater than or equal to 1 and less than or equal to N. The N first tabs 115 form N layers of tab rolls around a central axis of the wound body, that is, the first tabs 115 are in an integrated structure in the winding direction A (as shown in FIG. 3), which is essentially a full-tab structure, thereby reducing a safety risk caused by formation of burrs during die cutting of the first tabs 115. Alternatively, as shown in FIG. 5 to FIG. 7, the second part 111b includes N mutually separated first tabs 115 in the winding direction A. Compared with the full-tab structure, the mutually separated first tabs 115 are more convenient to connect to the first conductive member 33. In addition, before wound, the N mutually separated first tabs 115 may be as shown in FIG. 15 and FIG. 19, adjacent first tabs 115 have a same distance d3, and the adjacent first tabs 115 are misaligned in a radial direction after the first electrode plate 11 is wound, as shown in FIG. 6. Alternatively, before wound, the N mutually separated first tabs 115 may be as shown in FIG. 16 to FIG. 18 and FIG. 20 to FIG. 22, adjacent first tabs 115 have a distance d3 that gradually increases along the winding direction A, and the adjacent first tabs 115 can overlap in a radial direction after the first electrode plate 11 is wound by controlling the increase amplitude through simulated calculation, as shown in FIG. 5.

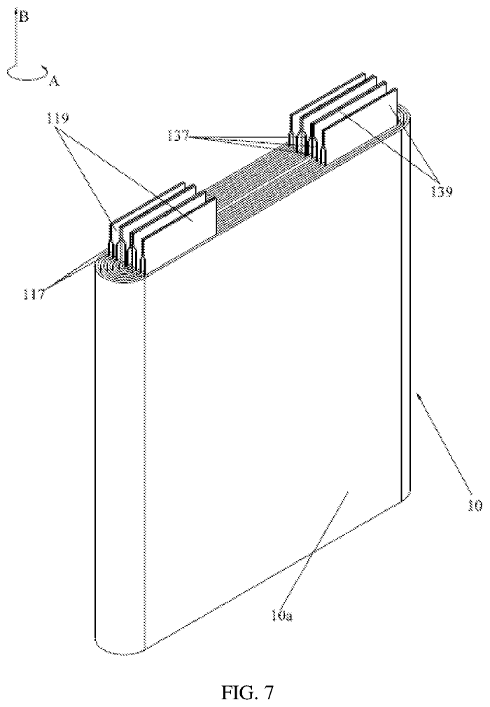

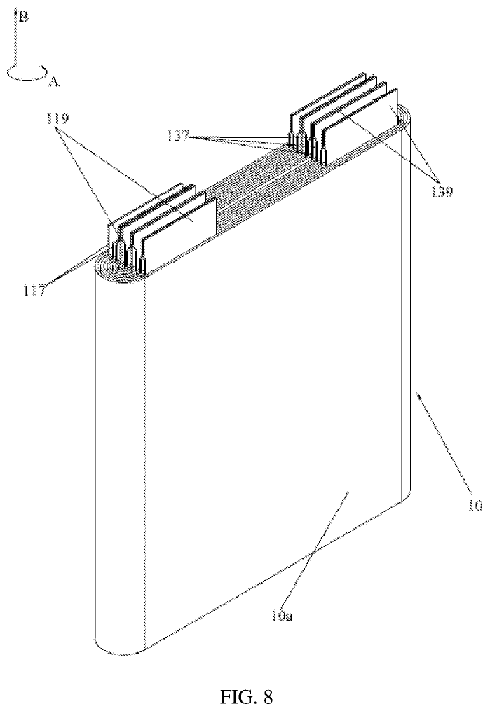

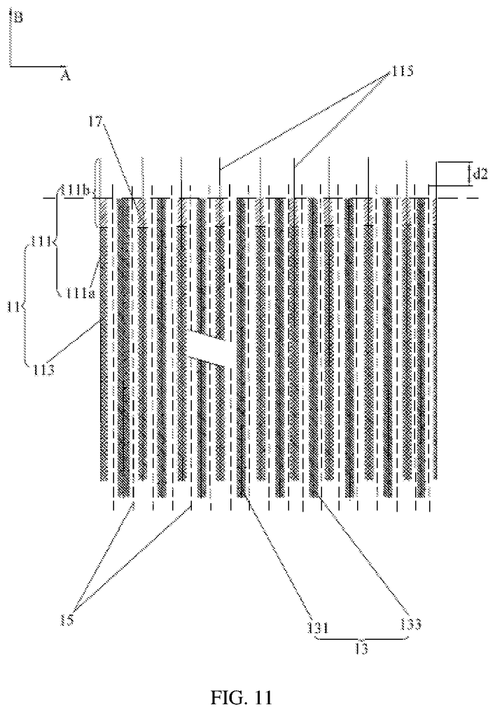

Besides, the first tabs 115 in this application can be connected to one side of the first connecting part 331 facing the electrode assembly 10a in various manners. As shown in FIG. 9, the N first tabs 115 are mutually separately directly connected to one side of the first connecting part 331 facing the electrode assembly 10a, and at this moment, M is equal to N. The multiple first tabs 115 are directly connected to the first connecting part 331 respectively, with a simple operation process. Alternatively, as shown in FIG. 7, FIG. 8 and FIG. 10, the N first tabs 115 are divided into M first tab groups 117, where M is an integer greater than or equal to 1 and less than N; the M first tab groups 117 include P first tab groups I and Q first tab groups II; the first tab group I includes one first tab; the first tab group II includes multiple first tabs; P is an integer greater than or equal to 0 and less than M; Q is an integer greater than 0 and less than M; and P+Q=M. Specifically, as shown in FIG. 7, 10 first tabs 115 are divided into 4 first tab groups 117. The 4 first tab groups 117 include 4 first tab groups II; multiple first tabs 115 in the 4 first tab groups II are stacked and welded to form first assembly parts 119; and the 4 first assembly parts 119 are mutually separately connected to one side of the first connecting part 331 facing the electrode assembly 10a. Alternatively, as shown in FIG. 8, 10 first tabs 115 are divided into 4 first tab groups 117. The 4 first tab groups 117 include 1 first tab group I and 3 first tab groups II. Multiple first tabs 115 in the 3 first tab groups II are stacked and welded to form first assembly parts 119; and one first tab 115 in the 1 first tab group I and the 3 first assembly parts 119 are mutually separately connected to one side of the first connecting part 331 facing the electrode assembly 10a. The number of the first assembly part 119 can be correspondingly regulated according to the number of winding turns of the electrode assembly 10a. When the number of the winding turns of the electrode assembly 10a is small, multiple first tabs 115 may be stacked and welded to form the first assembly part 119. When the number of the winding turns of the electrode assembly 10a is large, the number of the first tabs 115 for forming the first assembly part 119 can be reduced. In an electrode assembly 10a of a wound structure, compared with a winding outer circle, a winding inner circle uses a large number of first tabs 115 that are stacked and welded to form the first assembly part 119. The multiple first tabs 115 are grouped first, pre-welded and then connected to the first connecting part 331, thereby reducing a risk of a rosin joint or poor welding caused by mutual interference of lots of first tabs 115 that are present. In this application, stacking and folding are not required for connecting structures for the first tabs 115 and the first connecting part 331, so that the internal space, occupied by multiple tabs, of the housing 50 can be released, increasing the volumetric energy density and reducing a risk of a contact short circuit caused when the first conductive member 33 is reversely inserted into the electrode assembly 10a, thereby improving the safety. The second part 111b can be controlled to have a small size in the second direction B, thereby increasing the utilization rate of the first current collector 111 and reducing the cost. In actual operation, before winding, when the first tab 115 is in a suspended state (that is, a state before connection) in the second direction B, a size d2 of the first tab 115 exceeding the separator 15 may be 2 mm to 6 mm (as shown in FIG. 11), or an upper limit of d2 can approximately increase with increase of the winding turns of the electrode assembly 10a. The d2 being controlled within this parameter range can achieve current passing capability of the first tab 115 and can also increase the volumetric energy density and reduce the risk of a contact short circuit and the production cost. A distance d1 between the first connecting part 331 and the first part 111a (as shown in FIG. 9 and FIG. 10) is less than 1 mm. The distance d1 being controlled as this parameter can not only meet connection requirements but also increase the volumetric energy density.

Besides, this application is applicable to first tabs 115 with different sizes. Specifically, as shown in FIG. 15, FIG. 16, FIG. 18 to FIG. 20, and FIG. 22, before wound, the first tabs 115 have a same size d4 when in a suspended state in the second direction B. Such first tabs 115 can be mutually separately directly connected to one side of the first connecting part 331 facing the electrode assembly 10a, or the first tabs 115 are divided into first tab groups 117. Multiple first tabs 115 in each first tab group 117 are stacked and welded to form a first assembly part 119; and the first tab groups 117 are mutually separately connected to one side of the first connecting part 331 facing the electrode assembly 10a by virtue of the respective first assembly parts 119. Further, the size d4 of the first tab 115 in a suspended state in the second direction B is small, such that the internal space, occupied by the first tab 115, of the housing 50 can be released. A ratio of a length d4 of the first tab 115 to a distance d1 between the first connecting part 331 and the electrode assembly 10a is (2-8):1. The ratio being controlled within the foregoing range can prevent mutual interference of each first tab group 117 and the first connecting part 331 during welding due to an excessively large length d4 of the first tab 115, and also prevents insufficient welding strength due to short welded portions of each first tab group 117 and the first connecting part 331 caused by an excessively small length d4 of the first tab 115.

Alternatively, as shown in FIG. 17 and FIG. 21, the sizes d4 of the first tabs 115 in a suspended state (a state before connection) in the second direction B are not all the same. When such first tabs 115 are connected to the first connecting part 331, it is necessary to divide N first tabs 115 into M first tab groups 117, where M is an integer greater than or equal to 1 and less than N. Multiple first tabs 115 in each first tab group 117 are stacked and welded to form a first assembly part 119. The M first tab groups 117 are mutually separately connected to one side of the first connecting part 331 facing the electrode assembly 10a by virtue of the respective first assembly parts 119. A maximum size of the multiple first tabs 115 in a suspended state in the second direction B in each first tab group 117 is defined as Lmax, a minimum size is defined as Lmmin, and L=H/(n−1)is satisfied. L=Lmax−Lmmin, where H is a size of the first assembly part 119 in a thickness direction of the electrode assembly 10a, and n is the number of the first tabs 115 in the first tab group 117. The multiple first tabs 115 are grouped first, pre-welded and then connected to the first connecting part 331, and the formula L=H/(n−1) is satisfied, thereby reducing a risk of a rosin joint or poor welding caused during formation of the first assembly part 119.

Alternatively, the first tabs 115 have a same size d5 in the winding direction A, as shown in FIG. 15 to FIG. 17 and FIG. 19 to FIG. 21. The first tabs 115 may alternatively have different sizes d5 in the winding direction A, as shown in FIG. 18 and FIG. 22. In the case that the sizes d5 are different, it is preferable to divide N first tabs 115 into M first tab groups 117, where M is an integer greater than or equal to 1 and less than N. Multiple first tabs 115 in each first tab group 117 are stacked and welded to form a first assembly part 119. The M first tab groups 117 are mutually separately connected to one side of the first connecting part 331 facing the first part 111a by virtue of the respective first assembly parts 119.

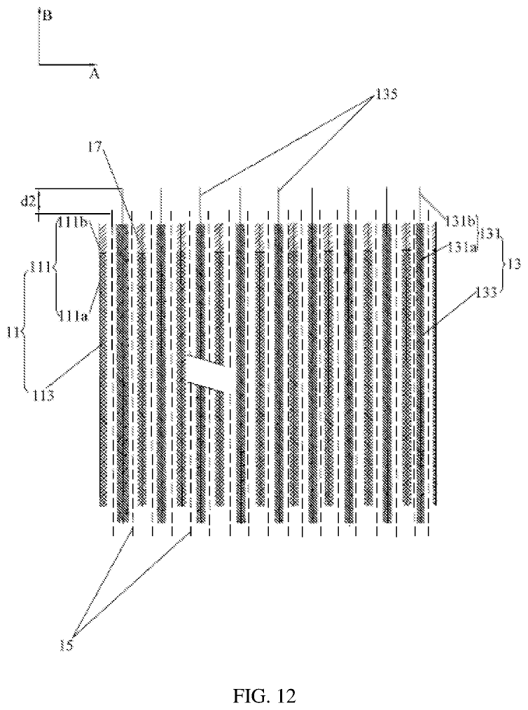

It should be further noted that the first tab 115 is formed on the first current collector 111 through die cutting, and thus burrs are formed at a die-cut edge. To reduce a safety risk such as occurrence of a short circuit, as shown in FIG. 11, FIG. 12, and FIG. 15 to FIG. 18, an insulating layer 17 is generally provided on the first electrode plate 11 in the winding direction A. The insulating layer 17 is provided on the second part 111b and in contact with the first active substance layer 113, and the insulating layer 17 extends to the first tab 115. Generally, the insulating layer 17 is provided on a cathode electrode plate, that is, the first electrode plate 11 is a cathode electrode plate, and the second electrode plate 13 is an anode electrode plate. With reference to connecting structures for the first tabs 115 and the first connecting part 331, the first tabs 115 do not need to be stacked and folded, so that it is less likely to cause reverse insertion of the first conductive member 33 into the electrode assembly 10a. In this application, the insulating layer 17 may be provided with a small size in the second direction B, and specifically, an edge of the insulating layer 17 can be controlled to be flush with an edge of the second active substance layer 133 (as shown in dotted line in FIG. 11). The size of the insulating layer 17 in the second direction B only needs to satisfy the requirement of reducing the safety risk caused by contact between the first current collector 111 and the anode electrode plate. Therefore, under a condition that the safety of the battery is unchanged, the production cost can be reduced and the energy density can be increased.

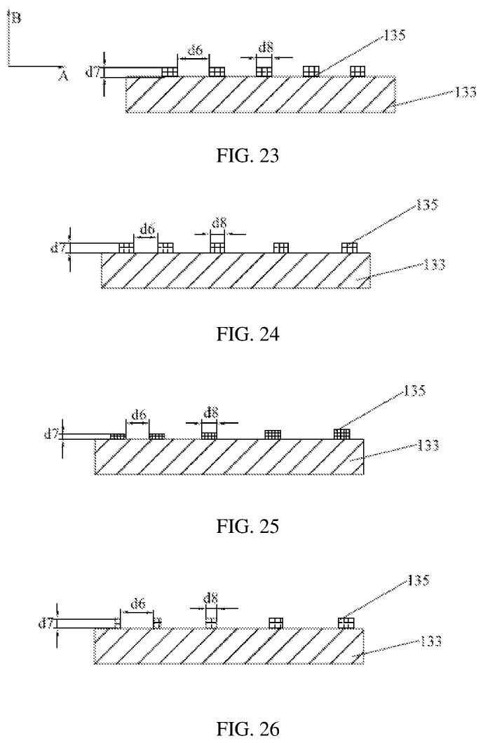

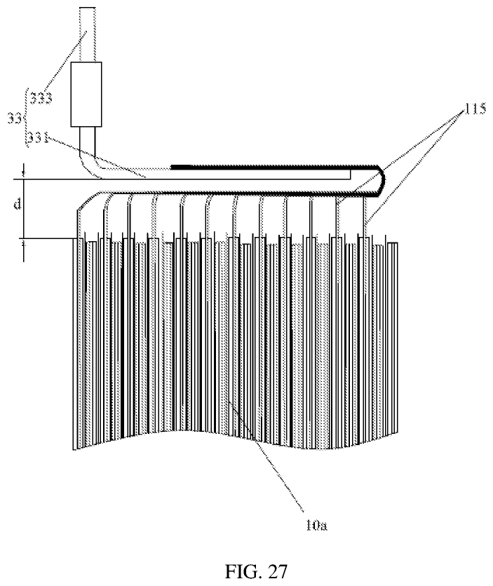

The second electrode plate 13 in this application can employ a structure similar to a structure of the first electrode plate 11. As shown in FIG. 3 to FIG. 7, FIG. 11 and FIG. 12, the second electrode plate 13 includes a second current collector 131 and a second active substance layer 133 provided on the second current collector 131. In the second direction B, the second current collector 131 includes a third part 131a provided with the second active substance layer 133 and a fourth part 131b provided with no second active substance layer 133. In the winding direction A, N second tabs 135 are integrally formed on the fourth part 111b. Alternatively, in the winding direction A, N second tabs 135 are connected to the second current collector 131, where N is an integer greater than 1. For ease of description, likewise, the second tabs 135 formed in the former manner are used as an example for description. The N second tabs 135 are divided into M groups, and the groups are mutually separately connected to one side of the second connecting part 351 facing the electrode assembly 10a, where M is an integer greater than or equal to 1 and less than or equal to M. The second tab 135 may be a full-tab structure shown in FIG. 3. Alternatively, as shown in FIG. 5 to FIG. 7, the fourth part 111b includes N mutually separated second tabs 135 in the winding direction A. Similarly, before wound, the N mutually separated second tabs 135 may be as shown in FIG. 24 to FIG. 26, adjacent second tabs 135 have a distance d6 that gradually increases along the winding direction A, and the adjacent second tabs 135 can overlap in a radial direction after the second electrode plate 13 is wound by controlling the increase amplitude through simulated calculation, as shown in FIG. 5. Alternatively, before wound, the N mutually separated second tabs 135 may be as shown in FIG. 23, adjacent second tabs 135 have a same distance d6, and the adjacent second tabs 135 are misaligned in a radial direction after the second electrode plate 13 is wound, as shown in FIG. 6.

The second tabs 135 may be connected to the second connecting part 351 of the second conductive member 35 in various manners as well. Similar to the first tabs 135 shown in FIG. 9, the N second tabs 135 are mutually separately directly connected to one side of the second connecting part 351 facing the electrode assembly 10a, and at this moment, M is equal to N. Alternatively, as shown in FIG. 7, 10 second tabs 135 are divided into 4 second tab groups 137. The 4 second tab groups 137 include 4 second tab groups II; multiple second tabs 135 in the 4 second tab groups II are stacked and welded to form second assembly parts 139; and the 4 second assembly parts 139 are mutually separately connected to one side of the second connecting part 351 facing the electrode assembly 10a. Alternatively, as shown in FIG. 8, 10 second tabs 135 are divided into 4 second tab groups 137. The 4 second tab groups 137 include 1 second tab group I and 3 second tab groups II. Multiple second tabs 135 in the 3 second tab groups II are stacked and welded to form second assembly parts 139; and one second tab 135 in the 1 second tab group I and the 3 second assembly parts 139 are mutually separately connected to one side of the second connecting part 351 facing the electrode assembly 10a. Similarly, a size d2 of the second tab 135 exceeding the separator 15 when the second tab 135 is in a suspended state in the second direction B may be 2 mm to 6 mm (as shown in FIG. 12), or an upper limit of d2 can approximately increase with increase of the winding turns of the electrode assembly 10a. A distance between the second connecting part 351 and the third part 131a may be less than 1 mm.

The second tabs 135 may have a same size d7 when in a suspended state in the second direction B. As shown in FIG. 23, FIG. 24 and FIG. 26, such second tabs 135 can be mutually separately directly connected to one side of the second connecting part 351 facing the electrode assembly 10a, or the second tabs 135 are divided into second tab groups 137. Multiple second tabs 135 in the second tab groups 137 are stacked and welded to form second assembly parts 139; and the second tab groups 137 are mutually separately connected to one side of the second connecting part 351 facing the electrode assembly 10a by virtue of the respective second assembly parts 139. Alternatively, as shown in FIG. 25, the sizes d7 of the second tabs 135 in a suspended state in the second direction B are not all the same. When such second tabs 135 are connected to the second connecting part 351, it is necessary to divide N second tabs 135 into M second tab groups 137, where M is an integer greater than or equal to 1 and less than N. Multiple second tabs 135 in each second tab group 137 are stacked and welded to form a second assembly part 139. The M second tab groups 137 are mutually separately connected to one side of the second connecting part 351 facing the electrode assembly 10a by virtue of the respective second assembly parts 139. Alternatively, the second tabs 135 have a same size d8 in the winding direction A, as shown in FIG. 23 to FIG. 25. The second tabs 135 may alternatively have different sizes d8 in the winding direction A, as shown in FIG. 26. In the case that the sizes d8 are different, it is preferable to divide N second tabs 135 into M second tab groups 137, where M is an integer greater than or equal to 1 and less than N. Multiple second tabs 135 in each second tab group 137 are stacked and welded to form a second assembly part 139. The M second tab groups 137 are mutually separately connected to one side of the second connecting part 351 facing the electrode assembly 10a by virtue of the respective second assembly parts 139.

In addition, the electrode assembly 10a of a laminated structure shown in FIG. 13 and FIG. 14 is used as an example for description. The first electrode plate 11 includes a first current collector 111 and a first active substance layer 113 provided on the first current collector 111. In the second direction B, the first current collector 111 includes a first part 111a provided with the first active substance layer 113 and a second part 111b provided with no first active substance layer 113. The second part 111b includes N first tabs 115 in the first direction A, where N is an integer greater than 1. The second electrode plate 13 includes a second current collector 131 and a second active substance layer 133 provided on the second current collector 131. In the second direction B, the second current collector 131 includes a third part 131a provided with the second active substance layer 133 and a fourth part 131b provided with no second active substance layer 133. The fourth part 131b includes N second tabs 135 in the first direction A, where N is an integer greater than 1. In the electrode assembly 10a of a laminated structure, connecting structures for the first tabs 115 and the first connecting part 331 and connecting structures for the second tabs 135 and the second connecting part 351 are similar to the foregoing wound structure. The N first tab groups 115 are divided into M groups, and the groups are mutually separately connected to one side of the first connecting part 331 facing the first part 111a. The N first tabs 115 may be mutually separately directly connected to one side of the first connecting part 331 facing the electrode assembly 10a. The N first tabs 115 may alternatively be divided into M first tab groups 117. Multiple first tabs 115 in each first tab group 117 are stacked and welded to form a first assembly part 119; and the first tab groups 117 are mutually separately connected to one side of the first connecting part 331 facing the first part 111a by virtue of the respective first assembly parts 119. Similarly, the N second tabs 135 are divided into M groups, and the groups are mutually separately connected to one side of the second connecting part 351 facing the electrode assembly 10a. The N second tabs 135 may be mutually separately directly connected to one side of the second connecting part 351 facing the third part 131a. The N second tabs 135 may alternatively be divided into M second tab groups 137. Multiple second tabs 135 in each second tab group 137 are stacked and welded to form a second assembly part 139; and the second tab groups 137 are mutually separately connected to one side of the second connecting part 351 facing the electrode assembly 10a by virtue of the respective second assembly parts 139. In addition, the first tabs 115 may have a same size or different sizes when in a suspended state in the second direction B, and the first tabs 115 may have a same size or different sizes in the third direction C. The second tabs 135 may have a same size or different sizes when in a suspended state in the second direction B, and the second tabs 135 may have a same size or different sizes in the third direction C. Further, the first tab 115 has a small size when in a suspended state in the second direction B, while the first connecting part 331 has a large size in the third direction C; alternatively, the second tab 135 has a small size when in a suspended state in the second direction B, while the second connecting part 351 has a large size in the third direction C, thereby providing a large connection area. Therefore, such structure can improve a connection effect while increasing the volumetric energy density of the battery, especially improve the welding quality.

In conclusion, it should be noted that the foregoing embodiments are merely intended to describe the technical solutions of this application rather than to limit the protection scope of this application. Although this application is described in detail with reference to preferred embodiments, it is not limited to those listed in the embodiments, and persons of ordinary skill in the art should understand that modifications or equivalent replacements can be made to the technical solutions of this application, without departing from the essence and scope of the technical solutions of this application.

What is claimed is:

1. A battery, comprising:
a housing, a battery cell, and a first conductive member, wherein
the housing is provided with an accommodating cavity, the battery cell being accommodated in the accommodating cavity;
the first conductive member comprises a first terminal part located outside the housing, and a first connecting part connected to the first terminal part and located inside the housing; the battery cell comprises an electrode assembly and N first tabs protruding from the electrode assembly, wherein N is an integer greater than 1;
the N first tabs are divided into M first tab groups, the first tab groups are separately connected to one side of the first connecting part facing the electrode assembly, and M is an integer greater than or equal to 1 and less than or equal to N.

2. The battery according to claim 1, wherein the M is equal to N, and the N first tabs are separately connected to the one side of the first connecting part.

3. The battery according to claim 1, wherein
the M is an integer greater than or equal to 1 and less than N;
the M first tab groups comprise P first tab sub-groups and Q second tab sub-groups;
each first tab sub-group comprises one first tab; each second tab sub-group comprises a plurality of first tabs;
P is an integer greater than or equal to 0 and less than M, Q is an integer greater than 0 and less than M, and P+Q=M;
the plurality of first tabs in the each second tab sub-group are stacked and welded to form a first assembly part; and
the first tabs in the P first tab sub-groups and the Q first assembly parts are mutually separately connected to the one side of the first connecting part.

4. The battery according to claim 1, wherein a distance between the first connecting part and the electrode assembly is less than 1 mm.

5. The battery according to claim 1, wherein the electrode assembly comprises a wound body formed by stacking and winding a first electrode plate, a separator and a second electrode plate in sequence, and the N first tabs form N layers of tab rolls around a central axis of the wound body.

6. The battery according to claim 1, wherein
the electrode assembly is formed by stacking and winding a first electrode plate, a separator and a second electrode plate in sequence; or
the electrode assembly is formed by stacking multiple first electrode plates, separators and second electrode plates in sequence, and a direction perpendicular to the first electrode plates, the separators and the second electrode plates is defined as a first direction.

7. The battery according to claim 6, wherein the N first tabs are separated from each other in a winding direction or the first direction.

8. The battery according to claim 1, wherein
the electrode assembly comprises a first electrode plate, a second electrode plate, and a separator provided between the first electrode plate and the second electrode plate;
the first electrode plate comprises a first current collector and a first active substance layer provided on the first current collector;
the first current collector extends to form the first tab; the first current collector is provided with an insulating layer; and
the insulating layer is in contact with the first active substance layer and extends to the first tab.

9. The battery according to claim 8, wherein
a direction in which the first tab protrudes from the electrode assembly is defined as a second direction;
the second electrode plate comprises a second current collector and a second active substance layer provided on the second current collector;
the first electrode plate is a cathode plate;
the second electrode plate is an anode plate; and
in the second direction, an edge of the insulating layer is flush with an edge of the second active substance layer.

10. The battery according to claim 1, wherein a ratio of a length of the first tab to a distance between the first connecting part and the electrode assembly is in a range of 2:1 to 8:1.

11. An electric apparatus, comprising the battery according to claim 1.

12. The electric apparatus according to claim 11, wherein the M is equal to N, and the N first tabs are separately connected to the one side of the first connecting part.

13. The electric apparatus according to claim 11, wherein
the M is an integer greater than or equal to 1 and less than N;
the M first tab groups comprise P first tab sub-groups and Q second tab sub-groups;
each first tab sub-group comprises one first tab; each second tab sub-group comprises a plurality of first tabs;
P is an integer greater than or equal to 0 and less than M, Q is an integer greater than 0 and less than M, and P+Q=M;
the plurality of first tabs in the each second tab sub-group are stacked and welded to form a first assembly part; and
the first tabs in the P first tab sub-groups and the Q first assembly parts are mutually separately connected to the one side of the first connecting part.

14. The electric apparatus according to claim 11, wherein a distance between the first connecting part and the electrode assembly is less than 1 mm.

15. The electric apparatus according to claim 11, wherein the electrode assembly comprises a wound body formed by stacking and winding a first electrode plate, a separator and a second electrode plate in sequence, and the N first tabs form N layers of tab rolls around a central axis of the wound body.

16. The electric apparatus according to claim 11, wherein
the electrode assembly is formed by stacking and winding a first electrode plate, a separator and a second electrode plate in sequence; or
the electrode assembly is formed by stacking multiple first electrode plates, separators and second electrode plates in sequence, and a direction perpendicular to the first electrode plates, the separators and the second electrode plates is defined as a first direction.

17. The electric apparatus according to claim 16, wherein the N first tabs are separated from each other in a winding direction or the first direction.

18. The electric apparatus according to claim 11, wherein
the electrode assembly comprises a first electrode plate, a second electrode plate, and a separator provided between the first electrode plate and the second electrode plate; the first electrode plate comprises a first current collector and a first active substance layer provided on the first current collector;
the first current collector extends to form the first tab; the first current collector is provided with an insulating layer; and
the insulating layer is in contact with the first active substance layer and extends to the first tab.

19. The electric apparatus according to claim 18, wherein
a direction in which the first tab protrudes from the electrode assembly is defined as a second direction; the second electrode plate comprises a second current collector and a second active substance layer provided on the second current collector;
the first electrode plate is a cathode plate;
the second electrode plate is an anode plate; and
in the second direction, an edge of the insulating layer is flush with an edge of the second active substance layer.

20. The electric apparatus according to claim 11, wherein a ratio of a length of the first tab to a distance between the first connecting part and the electrode assembly is in a range of 2:1 to 8:1.
